(19) United States
(12) Patent Application Publication
(10) Pub. No.: US 2023/0391301 A1
(43) Pub. Date: Dec. 7, 2023

(54) BRAKE BOOST ASSIST IMPLEMENTING MODIFIED PRESSURE VERSUS ACTUATOR DISPLACEMENT PROFILES

(71) Applicant: GM GLOBAL TECHNOLOGY OPERATIONS LLC, Detroit, MI (US)

(72) Inventors: Vikas Tukaram PAWAR, Canton, MI (US); James V. ROELL, Clarkston, MI (US)

(21) Appl. No.: 17/832,806

(22) Filed: Jun. 6, 2022

(51) Int. Cl. B60T 8/172; B60T 7/22; B60Q 9/00; B60T 8/171

(52) U.S. Cl. CPC B60T 8/172; B60T 7/22; B60Q 9/008; B60T 8/171; B60T 2210/32; B60T 2201/022; B60T 2250/04; B60T 2201/03; B60T 2210/36; B60T 2220/04; B60T 2270/82; B60T 2250/00

(57) ABSTRACT

A brake assistance system of a host vehicle includes: a memory that stores brake pressure versus brake actuator distance profiles; an object detection module that detects a nearing object and determines a location of the object relative to the host vehicle or a distance between the host vehicle and the object; and a brake assist module that determines a speed of the host vehicle relative to the object, and based on the speed of the host vehicle and the location or the distance, to generate a brake apply alert message instructing a driver of the host vehicle to actuate brakes of the host vehicle, and to initiate modification of the at least one brake pressure or force versus brake actuator distance profile or selection of one of the brake pressure or force versus brake actuator distance profiles to provide a boosted brake pressure or force profile for assisted braking.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to object detection and collision avoidance systems, and more particularly to brake assistance and vehicle deceleration control systems.

Vehicles can include deceleration control systems, object detection systems, collision avoidance systems, adaptive cruise control systems, forward collision warning systems, and autonomous vehicle control systems for detecting objects and taking actions to avoid a collision. For example, an adaptive cruise control system may adjust speed of a host vehicle to prevent collision with another vehicle in front of the host vehicle. As another example, a collision avoidance system may detect an oncoming vehicle and take an evasive action and/or perform a countermeasure to avoid colliding with the approaching vehicle. The actions performed may include applying the brake to decelerate the host vehicle.

### SUMMARY

A brake assistance system of a host vehicle is disclosed. The brake assistance system includes: a memory configured to store at least one brake pressure versus brake actuator distance profile, an object detection module configured to detect a nearing object and determine at least one of a location of the object relative to the host vehicle and a distance between the host vehicle and the object; a brake assist module configured to determine a speed of the host vehicle relative to the object, and based on the speed of the host vehicle and at least one of the location of the object and the distance, i) to generate a brake apply alert message instructing a driver of the host vehicle to actuate brakes of the host vehicle, and ii) initiate modification of the at least one brake pressure or force versus brake actuator distance profile or selection of one of the at least one brake pressure or force versus brake actuator distance profile, to provide a boosted brake pressure or force profile for assisted braking; and an electronic control module configured to control brake pressure or force according to the boosted brake pressure or force profile to provide the assisted braking.

In other features, the brake assist module is configured to select the one of the at least one brake pressure or force versus brake actuator distance profile to provide the boosted brake pressure or force profile. At least a majority of the selected one of the at least one brake pressure or force versus brake actuator distance profile provides boosted brake pressure or boosted brake force as compared to another one of the at least one brake pressure or force versus brake actuator distance profile used when assisted braking is not performed.

In other features, the object detection module is configured to detect the object based on information received from at least one of an object detection sensor, a MAP module, and a GPS receiver.

In other features, the brake assistance system further includes a brake actuator sensor configured to detect position of a brake actuator and to generate a brake actuator signal indicating the position. The electronic control module is configured, based on the brake actuator signal, to control brake pressure according to the boosted brake pressure or force profile.

In other features, the brake assist module is configured to determine acceleration or deceleration of the host vehicle relative to the object, and based on the acceleration or deceleration of the host vehicle, to provide the assisted braking.

In other features, the brake assist module is configured to determine at least one of a heading of the host vehicle and a heading of the object, and based on the at least one of the heading of the host vehicle and the heading of the object, to provide the assisted braking.

In other features, the at least one brake pressure or force versus brake actuator distance profile includes a first brake pressure or force versus brake actuator distance profile and a second brake pressure or force versus brake actuator distance profile. The electronic control module is configured to: control the brake pressure or force according to the first brake pressure or force versus brake actuator distance profile when boosted brake pressure or force is not warranted; and control the brake pressure or force according to the second brake pressure or force versus brake actuator distance profile when boost brake pressure or force is warranted.

In other features, the brake assist module or the electronic control module determines that the host vehicle will not stop ahead of the object if the brake pressure or force is controlled according to the first brake pressure or force versus brake actuator distance profile, and based on this determination, selects the second brake pressure or force versus brake actuator distance profile.

In other features, the electronic control module controls a motor to control the brake pressure or force.

In other features, the electronic control module provides assisted braking at least one of i) while collision imminent braking is disabled, and ii) while collision imminent braking is enabled to prevent activation of collision imminent braking.

In other features, a method of operating a brake assistance system of a host vehicle is disclosed. The method includes: storing brake pressure or force versus brake actuator distance profiles; detecting a nearing object and determining at least one of a location of the object relative to the host vehicle and a distance between the host vehicle and the object; determining a speed of the host vehicle relative to the object; based on the speed of the host vehicle and at least one of the location of the object and the distance, i) generating a brake apply alert message instructing a driver of the host vehicle to actuate brakes of the host vehicle, and ii) initiating selection of one of the brake pressure or force versus brake actuator distance profiles with a boosted brake pressure or force profile for assisted braking; and controlling brake pressure of a brake control system according to the selected one of the brake pressure or force versus brake actuator distance profiles to provide the assisted braking.

In other features, at least a majority of the selected one of the brake pressure or force versus brake actuator distance profiles provides boosted brake pressure as compared to another one of the brake pressure or force versus brake actuator distance profiles used when assisted braking is not performed.

In other features, the method further includes detecting the object based on information received from at least one of an object detection sensor, a MAP module, and a GPS receiver.

In other features, the method further includes: detecting position of a brake actuator and generating a brake actuator signal indicating the position; and based on the brake actuator signal, controlling brake pressure or force according to the selected one of the brake pressure or force versus brake actuator distance profiles.

In other features, the method further includes determining acceleration or deceleration of the host vehicle relative to the object, and based on the acceleration or deceleration of the host vehicle, providing the assisted braking.

In other features, the method further includes determining at least one of a heading of the host vehicle and a heading of the object, and based on the at least one of the heading of the host vehicle and the heading of the object, providing the assisted braking.

In other features, the method further includes: controlling the brake pressure or force according to a first brake pressure or force versus brake actuator distance profile when boosted brake pressure or force is not warranted; and controlling the brake pressure according to a second brake pressure or force versus brake actuator distance profile when boost brake pressure or force is warranted. The brake pressure versus brake actuator distance profiles include the first brake pressure or force versus brake actuator distance profile and the second brake pressure or force versus brake actuator distance profile.

In other features, the method further includes determining that the host vehicle will not stop ahead of the object if the brake pressure or force is controlled according to the first brake pressure or force versus brake actuator distance profile, and based on this determination, selecting the second brake pressure or force versus brake actuator distance profile.

In other features, the method further includes controlling a motor to control the brake pressure or force.

In other features, the method further includes providing assisted braking at least one of i) while collision imminent braking is disabled, and ii) while collision imminent braking is enabled to prevent activation of collision imminent braking.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side view of an example braking situation illustrating braking distance according to a preset brake pressure versus brake actuator displacement profile without brake boost assistance;

FIG. 2 is a side view of an example braking situation illustrating braking distance using a modified brake pressure versus brake actuator displacement profile providing brake boost assistance in accordance with the present disclosure;

FIG. 3 is a functional block diagram of a vehicle including a brake control system including a brake assist module in accordance with the present disclosure;

FIG. 4 is a function block diagram of the brake control system in accordance with the present disclosure;

FIG. 5 is a plot of multiple brake pressure versus brake actuator displacement profiles in accordance with the present disclosure;

FIG. 6 is a plot of multiple brake force versus brake actuator displacement profiles in accordance with the present disclosure; and

FIGS. 7A-7B illustrate a brake assistance method in accordance with the present disclosure.

In the drawings, reference numbers may be reused to identify similar and/or identical elements.

### DETAILED DESCRIPTION

Traditional collision avoidance systems, such as collision imminent braking (CIB) and automatic emergency braking (AEB) systems perform emergency braking at a high decelerate rate (e.g., 0.5-1.0 g of deceleration, where g is acceleration due to gravity). The braking is typically applied as a last-ditch effort (or as a last line of defense) to prevent a collision. These types of systems detect an approaching object and autonomously apply the brakes of a vehicle to prevent a collision and/or to minimize the collision impact.

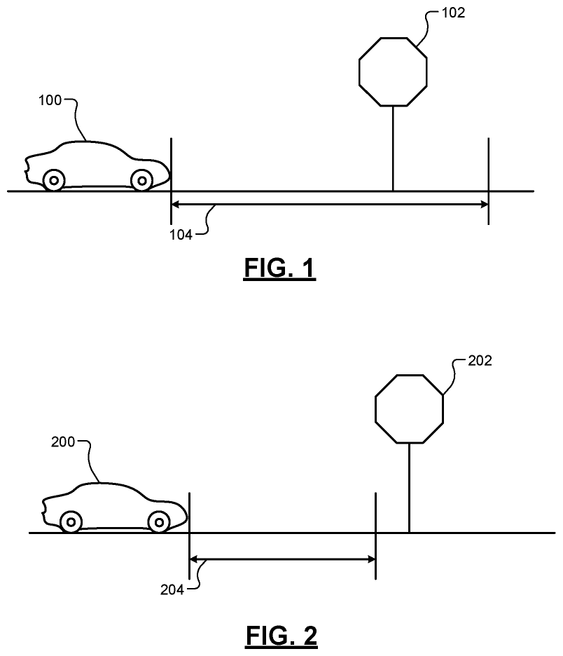

Certain situations can arise when an object is detected late, such that increased rate of deceleration is warranted. For example, a host vehicle may be approaching a stop sign or an intersection having a traffic light indicating that the host vehicle should stop. However, because of an obstructed view due to for example a large truck being located between the host vehicle and the stop sign and/or the traffic light, host vehicle braking is started late. FIG. 1 illustrates this example and shows a host vehicle 100 approaching a stop sign 102. When the driver and/or autonomous control of the vehicle begins braking, the host vehicle 100 may not stop at the stop sign as illustrated by the braking distance associated with inadequate brake pressure being applied. This extended braking distance can also occur when the driver misjudges the required amount of braking to stop ahead of the stop sign. If the vehicle is equipped with autonomous brake control, the extended braking distance can occur if the autonomous brake control system did not detect the stop sign via, for example, vison sensors and/or the stop sign was not included in available MAP and/or route information.

As another example, a controller of an autonomous vehicle may request that a driver take over control when it is determined that the autonomous vehicle is moving too fast and there is a risk of a collision with a detected object and/or passing the object in the case of a traffic control object (e.g., a stop sign). If the driver takes over control, the drivers may need to provide more than nominal braking to stop the autonomous vehicle within a safe distance. If the driver does not provide the required level of braking, then there is a high probability of a collision occurring with the detected object and/or the autonomous vehicle passing the detected object, which could result in a collision with another object.

The examples set forth herein include a brake assistance system for assisting a driver of a host vehicle in decelerating and stopping the host vehicle ahead of an object. The object may be an inanimate stationary or moving object, such as a vehicle, a traffic control device (e.g., traffic light, railroad crossing signal, stop sign, etc.), a roadblock sign, a boulder, a curb, etc. The object may be an animate object, such as a pedestrian or an animal. The brake assistance system includes a vision system for detection of objects and a brake control device for changing brake pressure versus brake actuator distance profiles. A brake pressure versus brake actuator distance profile refers to a relationship between pressure and/or force within a brake system and an amount of displacement by a driver of a brake actuator (e.g., a brake pedal). A different brake pressure versus brake actuator distance profile is selected to boost braking pressure and assist a driver in stopping a host vehicle ahead of a detected object.

The examples include detecting when a host vehicle is, for example, moving too fast and there is a high probability that a driver of the host vehicle will not stop the host vehicle prior to reaching a detected object. This determination may be based on i) use of a baseline or fixed preset brake pressure and/or brake force versus brake actuator distance profile, and/or ii) the driver either not applying the brakes or only providing nominal brake pressure. Various brake pressure versus brake actuator distance profiles are referred to below. Any of these various brake pressure versus brake actuator distance profiles may be replaced with and/or used in combination with brake force versus brake actuator distance profiles.

The disclosed brake assistance system requests that the driver apply the brakes and assists the driver in stopping ahead of the detected object by i) boosting the pressures of the preset brake pressure versus brake actuator distance profile, and/or ii) selecting another brake pressure versus brake actuator distance profile with higher pressures than pressures of the preset brake pressure versus brake actuator distance profile. The resulting boosted brake pressure profile increases probability of the host vehicle stopping prior to reaching the object. The boosted brake pressure profile may be utilized for a limited amount of time to stop the host vehicle within a safe distance of a detected object and then may revert back to using the present brake pressure versus brake actuator profile. The brake assistance system thus allows the host vehicle to be stopped by the driver while displacing a brake actuator (or brake pedal) a same amount of displacement as normally conducted for nominal braking. This is done while the brake assistance system actually applies brake pressure higher than that associated with nominal braking.

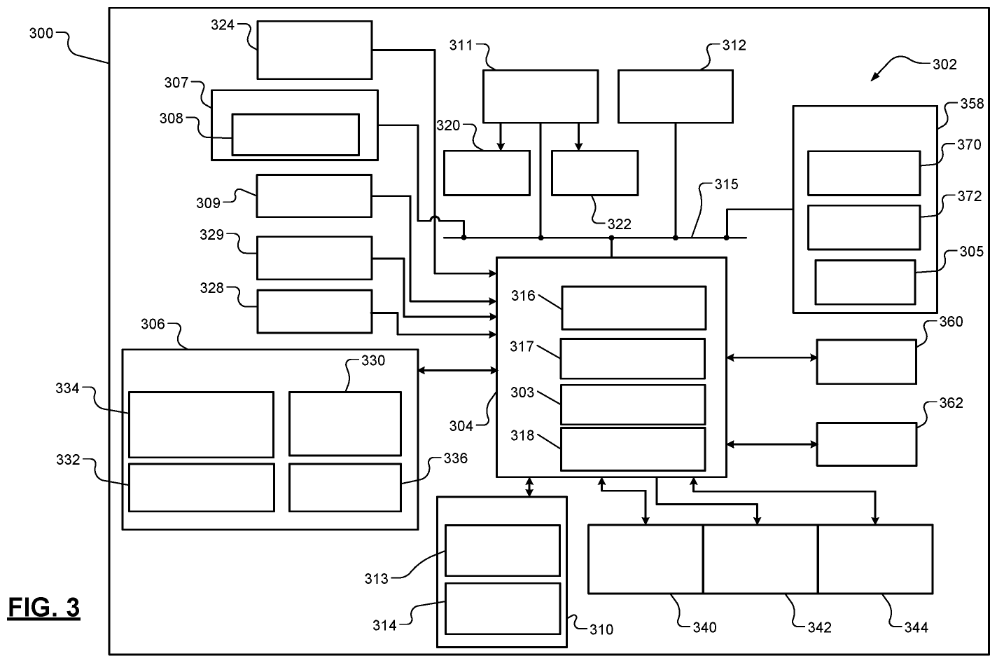

FIG. 2 shows an example of the disclosed brake control system providing brake assistance for the same example described above. A host vehicle 200 equipped with the disclosed brake control system is approaching a stop sign 202. The stop sign is detected and the brake control system selects and/or modifies a brake pressure versus brake actuator distance profile (referred to as “boosted brake pressure profile”) to assist the driver by boosting brake pressures for the same amount of displacement in a brake actuator as occurred during the example of FIG. 1. By applying a boosted brake pressure profile, additional pressures are applied and the host vehicle 200 stops ahead of the stop sign 202. This is designated by the braking distance 204, which occurs due to the boost in braking. The braking distance 204 is less than the braking distance 104 of FIG. 1.

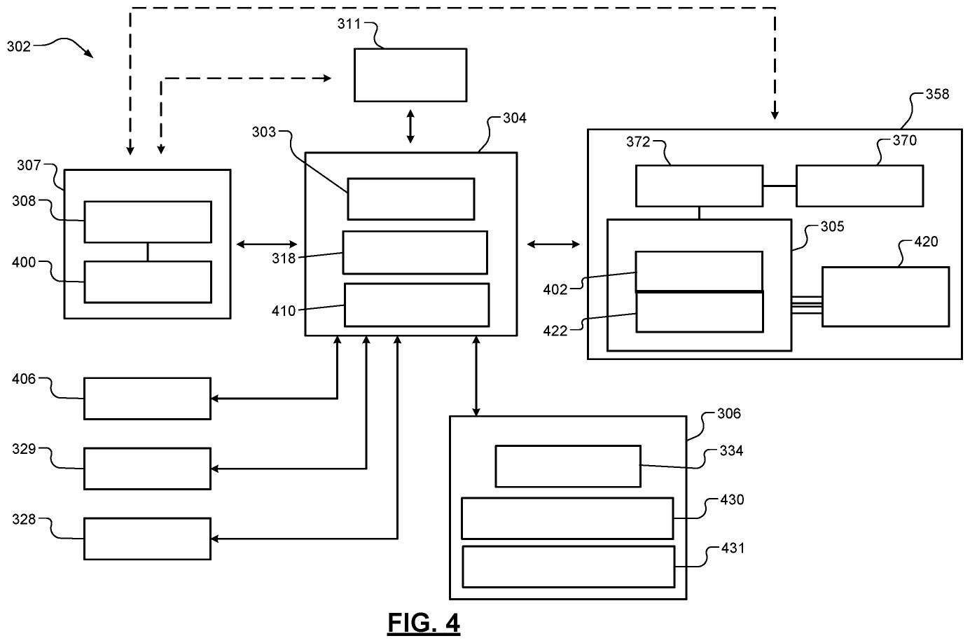

FIG. 3 shows a vehicle 300 including a brake control system 302 including a brake assist module 303. Although the brake assist module 303 is shown as being implemented at a vehicle control module 304, the brake assist module 303 may be implemented at an electronic braking control module (EBCM) 305. The brake assist module 303 and/or the EBCM 305 provides brake assistance including providing boosted brake pressure and/or force according to a selected brake pressure or force versus brake actuator distance profile, as further described below.

The vehicle 300 may be a non-autonomous, partially autonomous or fully autonomous vehicle. The vehicle 300 may be non-electric, hybrid or fully electric vehicle. The vehicle 300 includes vehicle control module 304, a memory 306, a vision sensing (or perception) system 307 including object detection sensors 308, and other sensors 309. The vehicle 300 may further include a power source 310, an infotainment module 311 and other control modules 312. The power source 310 includes one or more battery packs (one battery pack 313 is shown) and a control circuit 314. The object detection sensors 308 may include cameras, radar sensors, lidar sensors, etc. The other sensors 309 may include temperature sensors, accelerometers, a vehicle velocity sensor, and/or other sensors. The modules 304, 305, 311, 312 may communicate with each other and have access to the memory 306 via one or more buses and/or network interfaces 315. The network interfaces 315 may include a controller area network (CAN) bus, a local interconnect network (LIN) bus, an auto network communication protocol bus, and/or other network bus.

The vehicle control module 304 controls operation of vehicle systems. The vehicle control module 304 may include the brake assist module 303, a mode selection module 316, a parameter adjustment module 317, an object detection module 318, as well as other modules. The mode selection module 316 may select a vehicle operating mode. The parameter adjustment module 317 may be used to adjust obtain and/or determine parameters of the vehicle 300 based on, for example, signals from the sensors 308, 309 and/or other devices and modules referred to herein.

The vehicle 300 may further include a display 320, an audio system 322, and one or more transceivers 324. The display 320 and/or audio system 322 may be implemented along with the infotainment module 311 as part of an infotainment system. The display 320 and/or audio system 322 may be used to indicate brake alert messages to apply brakes due to an approaching and/or nearing object.

The vehicle 300 may further include a global positioning system (GPS) receiver 328 and a MAP module 329. The GPS receiver 328 may provide vehicle velocity and/or direction (or heading) of the vehicle and/or global clock timing information. The GPS receiver 328 may also provide vehicle location information. The MAP module 329 provides map information. The map information may include traffic control objects, routes being traveled, and/or routes to be traveled between starting locations (or origins) and destinations. The vision sensing system 307, the GPS receiver 328 and/or the MAP module 329 may be used to determine location of objects and position of the host vehicle 300 relative to the objects. This information may also be used to determine i) heading information of the host vehicle 300 and/or the objects, and ii) a relative speed of the host vehicle 300 relative to the objects.

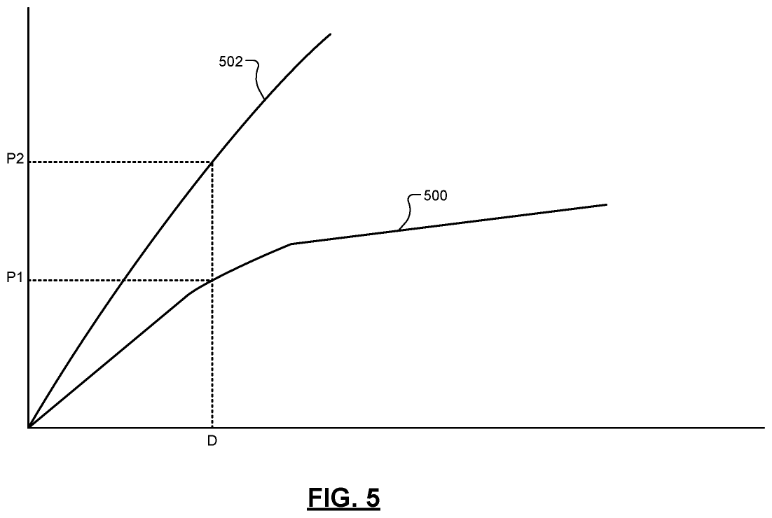

The memory 306 may store sensor data 330, vehicle parameters 332, a brake boost (or assist) application 334 and other applications 336. The brake boost application 334 may be implemented by the brake assist module 303 and/or the EBCM 305. The applications 336 may include applications executed by the modules 304, 311, 312. Although the memory 306 and the vehicle control module 304 are shown as separate devices, the memory 306 and the vehicle control module 304 may be implemented as a single device. The memory 306 may be accessible to the EBCM 305. The EBCM 305 may also include memory storing the brake boost application 334 and/or brake information, such as brake pressure or force versus brake actuator distance profiles. The brake pressure or force versus brake actuator distance profiles may be stored in the memory 306. See also FIG. 4.

The vehicle control module 304 may control operation of an engine 340, a converter/generator 342, a transmission 344, a brake control system 358, electric motors 360 and/or a steering system 362 according to parameters set by the modules 303, 304, 305, 311, 312, 318. The vehicle control module 304 may set some of the vehicle parameters 332 based on signals received from the sensors 308, 309. The vehicle control module 304 may receive power from the power source 310, which may be provided to the engine 340, the converter/generator 342, the transmission 344, the brake control system 358, the electric motors 360 and/or the steering system 362, etc. Some of the vehicle control operations may include enabling fuel and spark of the engine 340, starting and running the electric motors 360, powering any of the systems 302, 358, 362, and/or performing other operations as are further described herein.

The engine 340, the converter/generator 342, the transmission 344, the brake control system 358, the electric motors 360 and/or the steering system 362 may include actuators controlled by the vehicle control module 304 to, for example, adjust fuel, spark, air flow, steering wheel angle, throttle position, pedal position, etc. This control may be based on the outputs of the sensors 308, 309, the GPS receiver 328, the MAP module 329 and the above-stated data and information stored in the memory 306.

The brake control system 358 may be implemented as a brake-by-wire system and/or electronic brake boost system. In an embodiment, the brake control system 358 may include the EBCM 305, a brake actuator 370 and a brake actuator sensor 372. The brake actuator 370 may include a traditional style brake pedal and/or other brake actuator, such as a handheld brake actuator. The brake actuator sensor 372 detects position of the brake actuator 370, which is used to determine displacement of the brake actuator 370. The EBCM 305 may include a motor and an electronic control module for controlling operation of the motor. The motor may adjust brake pressure. The brake pressure may refer to pressure of a hydraulic fluid used to actuate brake pads.

The vehicle control module 304 may determine various parameters including a vehicle speed, an engine speed, an engine torque, a gear state, an accelerometer position, a brake pedal position, an amount of regenerative (charge) power, and/or other information.

FIG. 4 shows the brake control system 302 that includes the vehicle control module 304, the memory 306, the vision sensing system 307, the infotainment module 311, and the brake control system 358. The vision sensing system 307 may include the object detection sensor 308 and an object detection module 400. The object detection module 400 may be implemented at the vehicle control module 304. If implemented at the vision sensing system 307, the object detection module 400 may communicate with the infotainment module 311 and/or, for example, an electronic control module 402 of the EBCM 305. The object detection module 400 may operate similarly as the object detection module 318.

The object detection modules 400, 318 may detect objects, determine locations of the objects relative to the host vehicle, and headings and speeds of the objects and/or the host vehicle. The speed of the host vehicle may be determined via a vehicle speed sensor 406. The locations, headings and/or speeds of the host vehicle and the objects may be determined via the GPS receiver 328 and the MAP module 329. The object detection modules 400, 318 and/or the brake assist module 303, based on this location, heading and speed information, may determine whether braking and/or brake assistance is warranted. If yes, an alert message may be sent to the infotainment module 311 to indicate to the driver to apply the brakes. The alert message may be sent from any of the modules 303, 304, 318, 400 to the infotainment module 311.

The brake assist module 303 may i) select a brake pressure or force versus brake actuator distance profile (hereinafter referred to as the “selected profile”) and send the selected profile to the electronic control module 402 along with a current detected brake actuator displacement value, and/or ii) signal the electronic control module 402 a current detected brake actuator displacement value and object related information. The current detected brake actuator displacement value indicates a current position of the brake actuator 370. The electronic control module 402 may adjust brake pressure or force based on the selected profile and the current detected brake actuator displacement value. The brake pressure and force are directly related. In another embodiment, the electronic control module 402 selects the profile, based on information provided to the electronic control module 402, such as locations, headings, speeds and/or accelerations/decelerations of the host vehicle and detected object of concern.

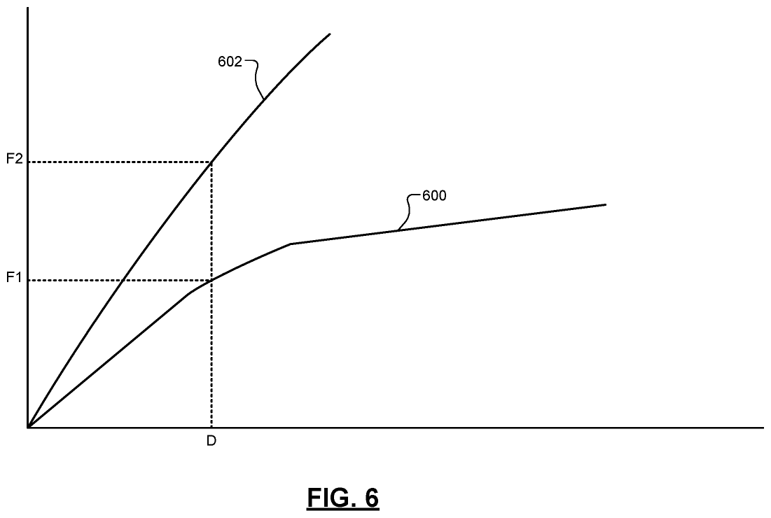

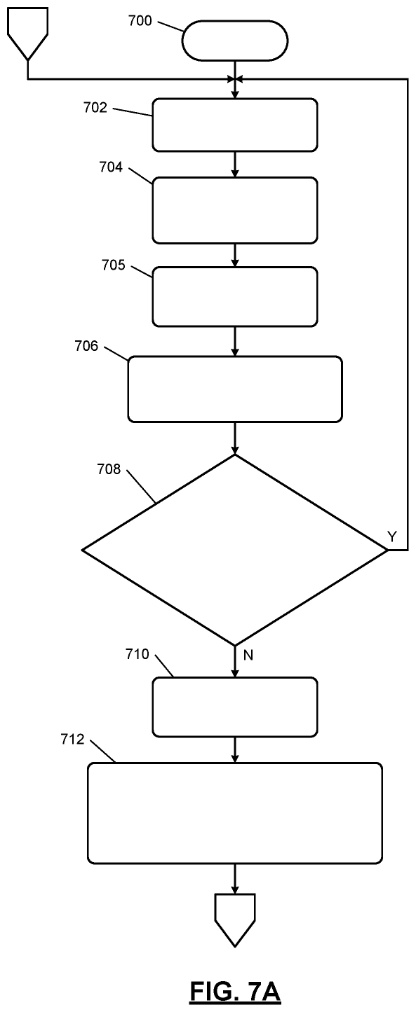

The objection detection modules 400, 318, the brake assist module 303 and the electronic control module 402 may perform operations as further described below with respect to FIGS. 5-6 to assist the driver in stopping the vehicle prior to reaching an approaching and/or nearing object.

The vehicle control module 304 may include a CIB (or AEB) module 410. The CIB module 410 may perform emergency braking as a last-ditch effort to prevent a collision and/or to minimize impact with an object. The CIB module 410 may be enabled or disabled by for example a driver. The CIB module 410 may autonomously apply brake pressure or force to provide greater than or equal to 0.5 g of deceleration. This is different than the amount of brake pressure or force applied by the brake assist module 303 while assisting in stopping a vehicle, which may, for example, provide an additional 0.2-0.5 g deceleration. Brake assistance may be implemented prior to collision imminent braking performed by the CIB module 410. In an embodiment, brake assistance is performed to avoid enabling the CIB module 410. The CIB module 410 may be enabled by, for example, the vehicle control module 304 when conditions arise that warrant emergency braking to avoid a collision. The CIB module 410 may be enabled when conditions arise for emergency braking, the CIB module 410 applies high brake pressure and/or force (e.g., pressure and/or force to provide greater than or equal to 0.5 g of deceleration). Application of this pressure is based on the distance and speed of the host vehicle relative to an approaching and/or nearing object. The thresholds that warrant collision imminent braking are different than the thresholds that warrant brake assistance provided by the brake assist module 303. For example, the threshold for relative distance may be less for a same relative speed as compared to that warranting brake assistance. As another example, the threshold for relative speed may be higher for a same relative distance as compared to that warranting brake assistance.

The brake control system 358 includes the EBCM 305, the brake actuator 370, the brake actuator sensor 372, and brake controllers and/or assemblies 420. The EBCM 305 includes the electronic control module 402 and a motor 422. The electronic control module 402 controls the motor 422 to adjust brake pressure. This may be based on a selected one of the brake pressure or force versus brake actuator distance profiles 430 stored in the memory 306 and/or pressures indicated by the brake assist module 303. This may additionally or alternatively be based on a selected one of brake force versus brake actuator distance profiles 431 stored in the memory 306 and/or forces indicated by the brake assist module 303. One of the brake pressure or force versus brake actuator distance profiles 430 may be selected by, for example, the brake assist module 303 and/or the electronic control module 402.

FIG. 5 shows a plot of multiple brake pressure versus brake actuator displacement profiles 500, 502. Although two profiles in FIG. 5 are shown, any number of profiles may be utilized and stored in the memory 306 of FIGS. 3-4. The profile 500 is an example of a profile utilized when brake assistance is disabled and/or not warranted. The profile 502 is an example of a profile utilized when brake assistance is enabled and warranted. As shown, when the brake actuator 370 is displaced a distance D, the brake pressure applied when brake assistance is not warranted is less than the brake pressure applied when brake assistance is warranted. Although the profile 502 is shown being entirely different than the profile 502, the profile 502 may include one or more points that are the same as that included in the profile 500. As an example, the profile 502 may include a portion of the same points as the profile 500. In an embodiment, a majority of points of the profile 502 is different than the points of the profile 500.

FIG. 6 shows a plot of multiple brake force versus brake actuator displacement profiles 600, 602. Although two profiles in FIG. 6 are shown, any number of profiles may be utilized and stored in the memory 306 of FIGS. 3-4. The profile 600 is an example of a profile utilized when brake assistance is disabled and/or not warranted. The profile 602 is an example of a profile utilized when brake assistance is enabled and warranted. As shown, when the brake actuator 370 is displaced a distance D, the brake force applied when brake assistance is not warranted is less than the brake force applied when brake assistance is warranted. Although the profile 602 is shown being entirely different than the profile 602, the profile 602 may include one or more points that are the same as that included in the profile 600. As an example, the profile 602 may include a portion of the same points as the profile 600. In an embodiment, a majority of points of the profile 602 is different than the points of the profile 600.

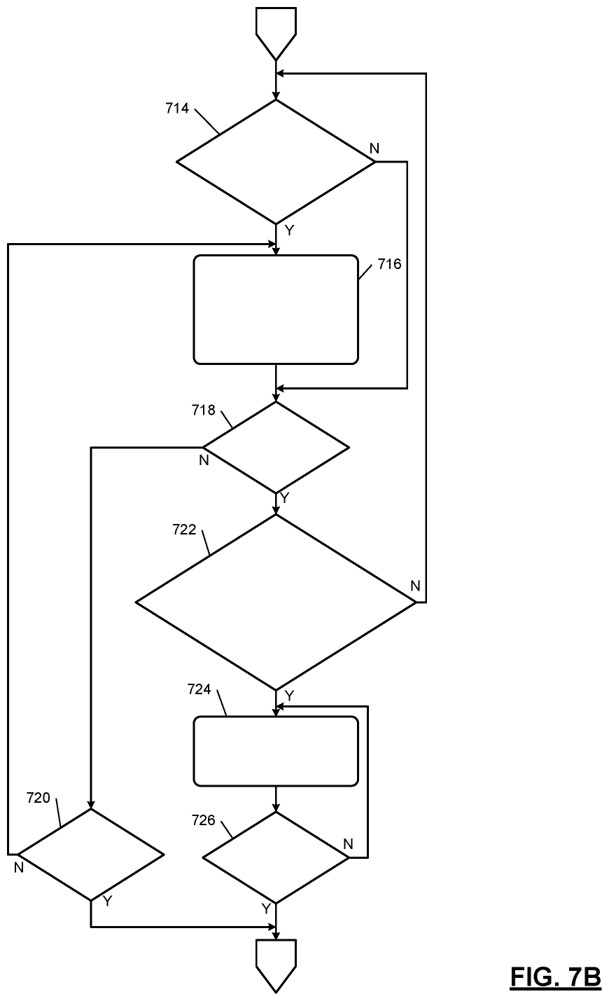

FIGS. 7A-7B shows a brake assistance method. The method is directed to example implementations of the brake control system shown in FIGS. 3-4. The operations may be iteratively performed. The method of FIGS. 7A-7B may be implemented when automatic cruise control and/or adaptive cruise control is deactivated.

The method may begin at 700. At 702, an object detection module 318 or 400 may detect an approaching and/or a nearing object and its location relative to the host vehicle. The object may be stationary or moving. The object may be detected and its location may be determined using the object detection sensors 308 of the vision sensing system 307 and/or information received from the GPS receiver 328 and/or the MAP module 329.

At 704, one of the modules 303, 304, 318, 400 determines the distance of the object relative to the host vehicle. At 705, one or more of the modules 303, 304, 318 determines the speed of the host vehicle relative to the object. At 706, the one or more of the modules 303, 304, 318 may determine the acceleration and/or deceleration of the host vehicle relative to the object. Operations 702, 704, 705, 706 may include determining headings of the host vehicle and the object.

At 708, one or more of the modules 303, 304, 318, 400 determines whether the host vehicle will stop ahead of the object based on the relative distance of the object, the current speed of the host vehicle relative to the object, acceleration (or deceleration) of the host vehicle relative to the object, and/or headings of the host vehicle and object. If yes, operation 702 may be performed, otherwise operation 710 may be performed.

At 710, one or more of the modules 303, 304, 318, 400 signals the infotainment module 311 to generate a brake apply alert message for the driver. The brake apply alert message is generated to indicate to the driver of the host vehicle to manually actuate the brake actuator 370 to apply brake pressure or force and stop the vehicle. This message may be an audible and/or video message. The message may be provided on a display on a dashboard, provided via a head-up display (HUD), provided via one or more speakers, etc.

At 712, the brake assist module 303 and/or the electronic control module 402 selects and/or modifies one of the brake pressure or force versus brake actuator distance profiles based on: the distance of the object relative to the host vehicle; headings of the host vehicle and object; speed of the object relative to the host vehicle; and/or the acceleration (or deceleration) of the vehicle relative to the object. The brake assist module 303 may generate a modification request signal and send the modification request signal to the electronic control module 402 to select a different brake pressure or force versus brake actuator distance profile. The modification request signal may include the distance of the object relative to the host vehicle; headings of the host vehicle and object; speed of the object relative to the host vehicle; and/or the acceleration (or deceleration) of the vehicle relative to the object. The electronic control module 402 may then select one of the brake pressure or force versus brake actuator distance profiles. The brake assist module 303 and/or the electronic control module 402 may determine that the host vehicle will not stop ahead of the object if the brake pressure or force is controlled according to a first brake pressure or force versus brake actuator distance profile, and based on this determination, selects a second brake pressure or force versus brake actuator distance profile to boost brake pressure or force. This changes i) the rate of change in brake pressure or force, and ii) the amounts of applied brake pressure or force, for positions of the brake actuator 370 to increase brake pressure or force throughout a braking event to stop the host vehicle ahead of the object.

In another embodiment, instead of selecting another brake pressure or force versus brake actuator distance profile, the brake assist module 303 and/or the electronic control module 402 multiplies the pressures or forces of a preset brake pressure or force versus brake actuator distance profile normally used when brake assistance is not warranted. This in effect provides another brake pressure or force versus brake actuator distance profile.

At 714, the electronic control module 402 may determine, based on a brake actuator signal from the brake actuator sensor 372 whether the driver has actuated the brake actuator 370 and the position of the brake actuator 370. If the brake actuator 370 has been moved and is in a nonzero state (e.g., brake pedal at least partially pressed), then operation 716 may be performed. If the brake actuator 370 has not been moved and/or is in a zero-position state (i.e., not depressed), then operation 718 may be performed.

At 716, the electronic control module 402 controls the motor 422 to adjust the brake pressure or force according to the selected one of the brake pressure or force versus brake actuator distance profiles. The brake pressure or force is boosted according to the selected one of the brake pressure or force versus brake actuator distance profiles to provide additional braking than would be normally provided for the current position of the brake actuator 370 when brake assistance is not warranted. As an example, the boosted brake pressure or force may provide an additional 0.2-0.5 g of deceleration i) over nominal braking pressure or force provided manually by the driver, and/or ii) over a brake pressure or force versus brake actuator distance profile when assisted braking is not warranted. The additional brake pressure or force may, for example, save 100-200 milliseconds of time to assure a safe stopping distance.

At 718, the electronic control module 402 may determine whether the CIB is enabled. If not enabled, operation 720 may be performed, otherwise operation 722 may be performed.

At 720, the electronic control module 402 determines whether the host vehicle has stopped moving. This may be based on the output of the vehicle speed sensor 406. If the host vehicle has stopped, operation 702 may be performed or the method may end. If the host vehicle has not stopped, operation 716 may be performed.

At 722, the electronic control module 402 may determine whether the distance of the object relative to the host vehicle; headings of the host vehicle and object; speed of the object relative to the host vehicle; and/or the acceleration (or deceleration) of the vehicle relative to the object satisfy thresholds for emergency braking. If the distance of the object relative to the host vehicle; headings of the host vehicle and object; speed of the object relative to the host vehicle; and/or the acceleration (or deceleration) of the vehicle relative to the object are indicative that a collision is imminent, then operation 724 may be performed to apply emergency brake pressure to stop the host vehicle, as described above. The brake pressure or force may be set to provide, for example, 0.5-1.0 g of deceleration.

At 726, the electronic control module 402 may determine whether the host vehicle has stopped, similar to operation 720. If the host vehicle has stopped, operation 702 may be performed or the method may end. If the vehicle has not stopped moving, operation 724 may be continued to be performed until the host vehicle has stopped.

The above-described operations are meant to be illustrative examples. The operations may be performed sequentially, synchronously, simultaneously, continuously, during overlapping time periods or in a different order depending upon the application. Also, any of the operations may not be performed or skipped depending on the implementation and/or sequence of events.

The above-described examples also allow a braking system when inadequate braking is conducted to recover and stop within a safe distance of a detected object. The examples also allow a braking system to stop within a safe distance when an object is suddenly detected. The examples include changing a brake pressure or force versus brake actuator distance profile. This is unlike forward collision warning and/or CIB operations, which do not include changing a brake pressure or force versus brake actuator distance profile. The assisted braking may be provided while forward collision warning and/or CIB are disabled and/or to prevent triggering of active operations, such as generating warning signals and/or braking, as performed by forward collision warning and/or CIB systems. As an example, forward collision warning operations may be implemented by the vehicle control module 304 of FIG. 3, based on detected objects, to prevent collision with the detected objects.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. These interface circuits may include CAN, LIN and/or auto network communication protocol interface. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A brake assistance system of a host vehicle, the brake assistance system comprising:
a memory configured to store at least one brake pressure versus brake actuator distance profile;
an object detection module configured to detect a nearing object and determine at least one of a location of the object relative to the host vehicle and a distance between the host vehicle and the object;
a brake assist module configured to determine a speed of the host vehicle relative to the object, and based on the speed of the host vehicle and at least one of the location of the object and the distance, i) to generate a brake apply alert message instructing a driver of the host vehicle to actuate brakes of the host vehicle, and ii) to initiate modification of the at least one brake pressure or force versus brake actuator distance profile or selection of one of the at least one brake pressure or force versus brake actuator distance profile, to provide a boosted brake pressure or force profile for assisted braking; and
an electronic control module configured to control brake pressure or force according to the boosted brake pressure or force profile to provide the assisted braking.

2. The brake assistance system of claim 1, wherein the brake assist module is configured to select the one of the at least one brake pressure or force versus brake actuator distance profile to provide the boosted brake pressure or force profile,
wherein at least a majority of the selected one of the at least one brake pressure or force versus brake actuator distance profile provides boosted brake pressure or boosted brake force as compared to another one of the at least one brake pressure or force versus brake actuator distance profile used when assisted braking is not performed.

3. The brake assistance system of claim 1, wherein the object detection module is configured to detect the object based on information received from at least one of an object detection sensor, a MAP module, and a GPS receiver.

4. The brake assistance system of claim 1, further comprising a brake actuator sensor configured to detect position of a brake actuator and to generate a brake actuator signal indicating the position,
wherein the electronic control module is configured, based on the brake actuator signal, to control brake pressure according to the boosted brake pressure or force profile.

5. The brake assistance system of claim 1, wherein the brake assist module is configured to determine acceleration or deceleration of the host vehicle relative to the object, and based on the acceleration or deceleration of the host vehicle, to provide the assisted braking.

6. The brake assistance system of claim 1, wherein the brake assist module is configured to determine at least one of a heading of the host vehicle and a heading of the object, and based on the at least one of the heading of the host vehicle and the heading of the object, to provide the assisted braking.

7. The brake assistance system of claim 1, wherein:
the at least one brake pressure or force versus brake actuator distance profile comprises a first brake pressure or force versus brake actuator distance profile and a second brake pressure or force versus brake actuator distance profile; and
the electronic control module is configured to
control the brake pressure or force according to the first brake pressure or force versus brake actuator distance profile when boosted brake pressure or force is not warranted; and
control the brake pressure or force according to the second brake pressure or force versus brake actuator distance profile when boost brake pressure or force is warranted.

8. The brake assistance system of claim 7, wherein the brake assist module or the electronic control module determines that the host vehicle will not stop ahead of the object if the brake pressure or force is controlled according to the first brake pressure or force versus brake actuator distance profile, and based on this determination, selects the second brake pressure or force versus brake actuator distance profile.

9. The brake assistance system of claim 1, wherein the electronic control module controls a motor to control the brake pressure or force.

10. The brake assistance system of claim 1, wherein the electronic control module provides assisted braking at least one of i) while collision imminent braking is disabled, and ii) while collision imminent braking is enabled to prevent activation of collision imminent braking.

11. A method of operating a brake assistance system of a host vehicle, the method comprising:
storing a plurality of brake pressure or force versus brake actuator distance profiles;
detecting a nearing object and determining at least one of a location of the object relative to the host vehicle and a distance between the host vehicle and the object;
determining a speed of the host vehicle relative to the object;
based on the speed of the host vehicle and at least one of the location of the object and the distance, i) generating a brake apply alert message instructing a driver of the host vehicle to actuate brakes of the host vehicle, and ii) initiating selection of one of the plurality of brake pressure or force versus brake actuator distance profiles with a boosted brake pressure or force profile for assisted braking; and
controlling brake pressure of a brake control system according to the selected one of the plurality of brake pressure or force versus brake actuator distance profiles to provide the assisted braking.

12. The method of claim 11, wherein at least a majority of the selected one of the plurality of brake pressure or force versus brake actuator distance profiles provides boosted brake pressure as compared to another one of the plurality of brake pressure or force versus brake actuator distance profiles used when assisted braking is not performed.

13. The method of claim 11, further comprising detecting the object based on information received from at least one of an object detection sensor, a MAP module, and a GPS receiver.

14. The method of claim 11, further comprising:
detecting position of a brake actuator and generating a brake actuator signal indicating the position; and
based on the brake actuator signal, controlling brake pressure or force according to the selected one of the plurality of brake pressure or force versus brake actuator distance profiles.

15. The method of claim 11, further comprising determining acceleration or deceleration of the host vehicle relative to the object, and based on the acceleration or deceleration of the host vehicle, providing the assisted braking.

16. The method of claim 11, further comprising determining at least one of a heading of the host vehicle and a heading of the object, and based on the at least one of the heading of the host vehicle and the heading of the object, providing the assisted braking.

17. The method of claim 11, further comprising:
controlling the brake pressure or force according to a first brake pressure or force versus brake actuator distance profile when boosted brake pressure or force is not warranted; and
controlling the brake pressure according to a second brake pressure or force versus brake actuator distance profile when boost brake pressure or force is warranted,
wherein the plurality of brake pressure versus brake actuator distance profiles comprise the first brake pressure or force versus brake actuator distance profile and the second brake pressure or force versus brake actuator distance profile.

18. The method of claim 17, further comprising determining that the host vehicle will not stop ahead of the object if the brake pressure or force is controlled according to the first brake pressure or force versus brake actuator distance profile, and based on this determination, selecting the second brake pressure or force versus brake actuator distance profile.

19. The method of claim 11, further comprising controlling a motor to control the brake pressure or force.

20. The method of claim 11, further comprising providing assisted braking at least one of i) while collision imminent braking is disabled, and ii) while collision imminent braking is enabled to prevent activation of collision imminent braking.
